(19) United States
(12) Patent Application Publication
(10) Pub. No.: US 2006/0102549 A1
(43) Pub. Date: May 18, 2006

(54) Co-molded and cured filter cartridge end using different durometer plastisols

(75) Inventor: Allen B. Wright, Hope Mills, NC (US)

Correspondence Address: CARLSON, GASKEY & OLDS, P.C., 400 WEST MAPLE ROAD, SUITE 350, BIRMINGHAM, MI, 48009, US

(73) Assignee: ArvinMeritor Technology, LLC

(21) Appl. No.: 10/991,747

(22) Filed: Nov. 18, 2004

(51) Int. Cl. B01D 27/00

(52) U.S. Cl. 210/450; 210/455; 210/493.1

(57) ABSTRACT

A filter cartridge includes a filter media having opposed edges. Annular end discs include first and second surfaces defined by spaced apart planes. The end discs has an integrated gasket, and is formal from includes first and second plastisol materials that have different durometers. The durometer of the second plastisol material makes it more rigid than the first plastisol material. The first plastisol material provides a flexible gasket. During manufacture, each edge of the filter media is embedded into the second material on an end disc. The second plastisol material is arranged between the planes, and the first plastisol material extends axially away from the second surface.

### BACKGROUND OF THE INVENTION

This invention relates to a filter cartridge for use in a fluid filter and to a method of manufacturing the same.

Filter cartridges are used in filter housings for filtering fluids such as oil and fuel. A filter cartridge typically includes spaced apart metal end discs with a filter media or element arranged between the end discs. Edges of the filter element, which may be a pleated paper element, are bonded to the end discs with an adhesive such as plastisol.

The surfaces of the end disc opposite of the filter element seal against the filter housing to prevent fluid from bypassing the filter element. The filter housing is typically constructed of metal so that there is a metal-to-metal seal between the filter cartridge end discs and the filter housing. This type of seal requires high control of the mating surfaces and preload to ensure a good seal. To improve the seal between the filter cartridge and filter housing, gaskets are sometimes bonded to the surfaces of the end discs opposite the filter element. Separately bonding a gasket to the metal end discs adds cost and time to the manufacture filter cartridge.

Integrated plastisol end discs and gaskets have been proposed in the prior art for other applications in which the end disc and gasket are made out of differing plastisols. However, the plastisol providing the flexible gasket is arranged radially inward of a central opening in the end discs. The end disc plastisol and gasket plastisol may well run together during the manufacturing process. This is not an issue in the prior art since a sealing load is applied in a radial direction. However, for filter cartridges configured, like those using metal end discs described above, the sealing load is applied axially. An axial sealing load requires a rigid end disc across the width of the filter element.

What is needed is a filter cartridge having improved, integrated end discs and gaskets and a method for making the same.

### SUMMARY OF THE INVENTION

One example of a filter cartridge of the present invention includes a filter media having an edge. An annular end disc includes first and second surfaces defined by spaced apart planes. An end disc and integrated gasket includes first and second plastisol materials that are different from one another and have different durometers. The durometer of the second plastisol material makes it more rigid than the first plastisol material. The first plastisol material provides a flexible gasket.

In one embodiment, the edge of the filter media is embedded into the second plastisol material. The second plastisol material is arranged between the planes, and the first plastisol material extends axially away from the second surface. This arrangement of the first and second plastisol materials better ensures that the materials do not mix with one another during dispensing and curing. The arrangement of the first and second plastisol materials provides a generally uniform rigidity across the width of the end disc ensuring better support of the filter media.

Accordingly, the present invention provides a filter cartridge having improved, integrated end discs and gaskets and a method making the same.

These and other features of the present invention can be best understood from the following specification and drawings, the following of which is a brief description.

### BRIEF DESCRIPTION OF THE DRAWINGS

FIG. 1 is a cross-sectional view of one prior art filter cartridge.

FIG. 2A is a top elevational view of a mold utilized in forming the inventive integrated end disc and gasket.

FIG. 2B is a cross-sectional view of the mold taken along lines 2B-2B of FIG. 2A.

FIG. 3 illustrates dispensing of a first plastisol material into the mold.

FIG. 4 illustrates dispensing a second plastisol material into the mold.

FIG. 5 is a cross-sectional view of a portion of the inventive filter cartridge curing in an oven.

FIG. 6 is a cross-sectional view of a completed filter cartridge utilizing one example method of the present invention.

### DETAILED DESCRIPTION OF THE PREFERRED EMBODIMENT

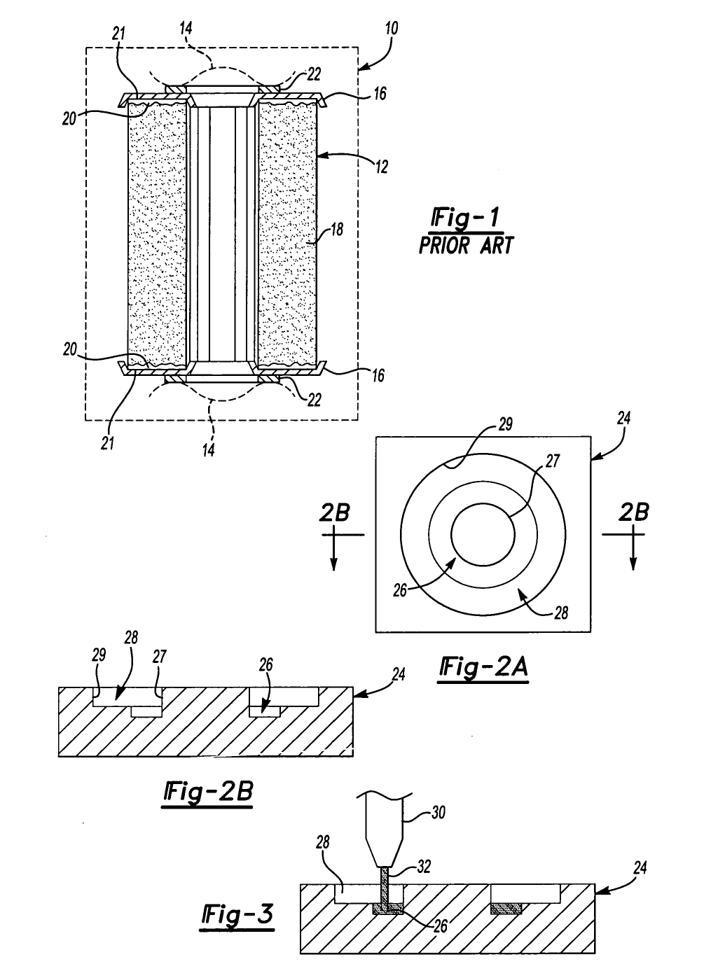

FIG. 1 illustrates one prior art filter cartridge for fluid filters. The filter cartridge 12 is arranged within a filter housing 10, which is depicted schematically. The filter housing 10 includes filter structure 14 against which the filter cartridge 12 must seal to prevent fluid from bypassing the filter cartridge 12. The filter cartridge 12 typically includes metal end discs 16 that retain a filter media or element 18. Adhesive 20 is arranged on one side of the end discs for securing edges 21 of the filter media 18 to the end discs 16. The filter media 18 is a pleated paper filter element in the example shown.

To better ensure that the filter cartridge seals against the filter structure 14, gaskets 22 are bonded to sides of the end disc 16 opposite the edges 21. The arrangement shown in FIG. 1 is costly since it requires separately adhering a gasket to each end disc. Further, the metal end discs cannot be incinerated when disposing of the filter.

An example inventive method of producing an inventive end disc uses the mold 24 depicted in FIGS. 2A-2B. The mold 24 can be constructed of any suitable material, such as metal, ceramic, plastic or glass. The mold 24 includes a first annular cavity 26 or recess that provides the shape of the inventive gasket. A second annular cavity 28 that, in this embodiment, is wider than the first annular cavity 26 is arranged axially above the first annular cavity 26 for reasons that will be described in greater detail below. The second annular cavity 28 provides inner and outer peripheral surfaces 27 and 29.

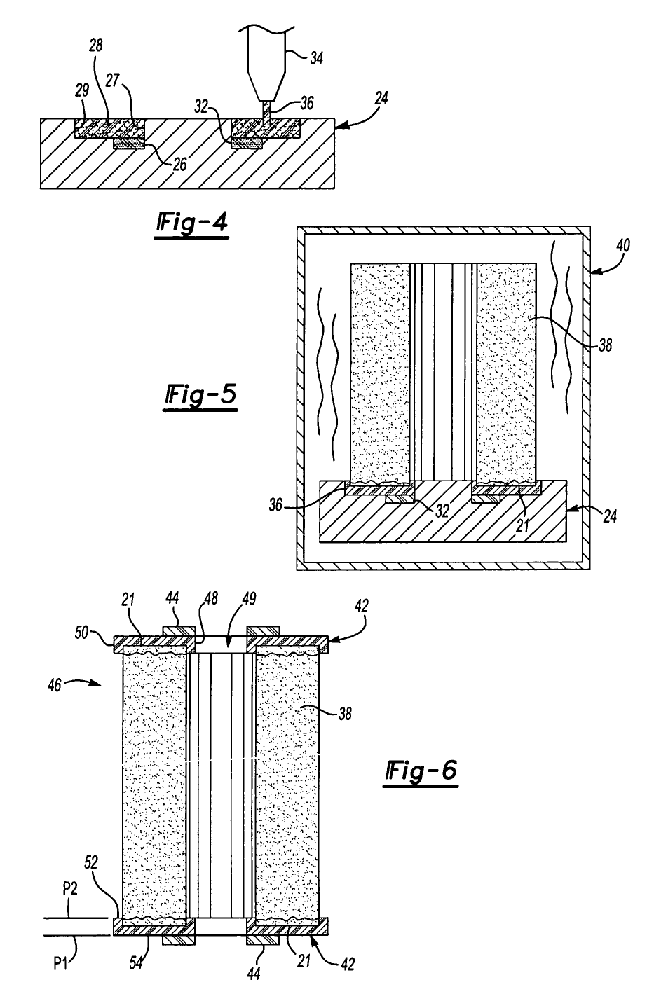

Referring to FIG. 3, a first plastisol material 32 is dispensed from a first dispenser 30 into the first annular cavity 26. A second plastisol material 36 is then dispensed from a second dispenser 34 into the second annular cavity 28, as shown in FIG. 4. The first and second plastisol materials 32 and 36 are different formulations than one another providing different durometers when cured. The first plastisol material 32 is more flexible than the second plastisol material 36. The first plastisol material 32 is suitable for use as a gasket, and the second plastisol material 36 is rigid when cured providing a suitable end disc. An integrated end disc and gasket is provided by the first and second plastisol materials 32 and 36 as a result of the curing process.

The formulations of the first and second plastisol materials 32 and 36 are such to minimize wet blending, which is a condition during which the materials intermix with one another. It is desirable to retain the first and second plastisol materials 32 and 36 within the volumes provided by the respective first and second cavities 26 and 28. It is also desirable that the rigid second plastisol material 36 extends from the inner peripheral surface 27 to the outer peripheral surface 29 to provide sufficient support for the edge 21 of the filter media 18 (see FIG. 1). Arranging the first plastisol material 32 radially inboard of the second plastisol material 36, as in the prior art, encourages the first and second plastisol materials 32 and 36 to blend with one another, which is undesirable.

A filter media 38 having an edge 21 is embedded into the second plastisol material 36 (as shown in FIG. 5). The mold 24 containing the first and second plastisol materials 32 and 36 along with the filter media 38 enters an oven 40 to cure the first and second plastisol materials 32 and 36.

Subsequent to completing the curing process shown in FIG. 5, another mold is filled with the first and second plastisol materials 32 and 36, as described above. An opposite edge of the filter media 38 is embedded into the newly filled mold. The newly filled mold and filter media 38 along with the already cured first and second plastisol materials 32 and 36 again enter the oven 40. A completed filter cartridge 46 is provided, as shown in FIG. 6. Alternatively, it may be desirable to provide a rigid end disc at the opposite edge of the filter media 38 to cover an opening 49 provided by the filter media 38. To form such a filter cartridge, the opposite edge of the filter media 38 is embedded in a mold filled with the rigid, second plastisol material 36. The first plastisol material 32 is unnecessary since the end of the filter media 38 is closed by the rigid end disc.

The inventive method provides integrated end discs 42 and gaskets 44. The end discs 42, which are provided by the second plastisol material 36, have inner and outer circumferential surfaces 48 and 50. The inner circumferential surfaces 48 provide the opening 49 that is aligned with an opening provided by the filter media 38. The end discs 42 include first and second surfaces 52 and 54 that are respectively defined by first and second planes P1 and P2. The edges 21 of the filter media 38 extend through the first surfaces 52 into the second plastisol material 36. The gaskets 44 extend axially away from the second surfaces 54 in a direction opposite the edge 21. In the embodiment shown in FIG. 6, the gaskets 44 are arranged radially outward of the inner circumferential surfaces 48 of the end discs 42.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A filter cartridge comprising:
a filter media having an edge; and
an end disc and an integrated gasket formed by first and second polymer materials, the second polymer material being more rigid than the first polymer material, the end disc formed by the second polymer material and including first and second surfaces defined by spaced apart planes, the edge in contact with the end disc at the first surface, and the first polymer material providing the integrated gasket extending axially away from the second surface.

2. The filter cartridge according to claim 1, wherein the edge is embedded in the second polymer material.

3. The filter cartridge according to claim 1, wherein the end disc includes inner and outer circumferential surfaces extending between the first and second surfaces, the inner circumferential surface providing a central opening in the end disc.

4. The filter cartridge according to claim 3, wherein the integrated gasket is spaced substantially radially inward of the outer circumferential surface.

5. The filter cartridge according to claim 3, wherein an exterior of the filter media is arranged radially inboard of the outer circumferential surface.

6. The filter cartridge according to claim 1, wherein the integrated gasket provides a sealing surface generally parallel to and outside of the second surface.

7. The filter cartridge according to claim 1, wherein the filter media is a pleated paper filter element.

8. The filter cartridge according to claim 1, wherein the first polymer material is spaced from the edge.

9. The filter cartridge according to claim 1, wherein the first and second polymer materials are plastisol.

10. A method of manufacturing a filter cartridge comprising the steps of:
a) dispensing a first polymer material in a first cavity;
b) dispensing a second polymer material in a second cavity communicating with the first cavity;
c) embedding a filter media in the second polymer material; and
d) curing the first and second polymer materials.

11. The method according to claim 10, wherein the first polymer material provides a gasket and the second polymer material provides an end disc.

12. The method according to claim 10, wherein the second polymer material flows radially outwardly during step b) forming inner and outer circumferential surfaces, the first polymer material arranged radially outward of the inner circumferential surface.

13. The method according to claim 10, wherein the second polymer material provides first and second surfaces defining spaced apart planes, the filter media extending through the first surface, the first polymer material extending axially outward from the second surface.

14. The method according to claim 10, comprising the steps of:
e) dispensing the first polymer material in a third cavity;
f) dispensing the second polymer material in a fourth cavity communicating with the third cavity;
g) reorienting the filter media;
h) embedding the filter media in the second polymer material in the fourth cavity; and
i) curing the first and second polymer materials in the third and fourth cavities.

15. The method according to claim 10, wherein the first and second polymer materials are plastisol.

16. The method according to claim 10, wherein the second cavity is arranged axially above the first cavity.
